(19) United States
(12) Patent Application Publication
(10) Pub. No.: US 2024/0254034 A1
(43) Pub. Date: Aug. 1, 2024

(54) ALKALI DOPED MULITCORE OPTICAL FIBER WITH REDUCED DEVITRIFICATION

(71) Applicant: CORNING INCORPORATED, CORNING, NY (US)

(72) Inventors: Leon Devone, JR., Wilmington, NC (US); Matthew Ryan Drake, Big Flats, NY (US); Rostislav Radiyevich Khrapko, Corning, NY (US); Pushkar Tandon, Painted Post, NY (US); Matthew Artus Tuggle, Seattle, WA (US)

(21) Appl. No.: 18/417,324

(22) Filed: Jan. 19, 2024

Related U.S. Application Data
(60) Provisional application No. 63/442,511, filed on Feb. 1, 2023.

(51) Int. Cl. C03C 13/04; C03B 37/027; C03C 3/06

(52) U.S. Cl. CPC C03C 13/046; C03B 37/02718; C03C 3/06; C03C 2201/11; C03C 2201/50

(57) ABSTRACT

A method of making a multicore optical fiber preform, the method including consolidating a preform assembly to form the multicore optical fiber preform, the preform assembly including a plurality of core canes such that each core cane is disposed within an axial hole of a sleeve, each core cane including a core section of alkali doped silica glass such that the silica glass has a maximum alkali concentration between about 0.10 wt. % and about 10 wt. %, the core section of each core cane being encased by the sleeve along a height of the core cane and by covers disposed at first and second axial ends of the core section, and the covers including silica glass having a chlorine concentration of about 0.05 wt. % or less.

This application claims the benefit of priority under 35 U.S.C § 120 of U.S. Provisional Application Ser. No. 63/442,511 filed on Feb. 1, 2023, the content of which is relied upon and incorporated herein by reference in its entirety.

### FIELD OF THE DISCLOSURE

The present disclosure is generally directed to alkali doped multicore optical fibers and, more particularly relates to cane-based multicore optical fibers with alkali doped cores and with reduced devitrification, and methods of forming thereof.

### BACKGROUND OF THE DISCLOSURE

Multicore optical fibers have increased transmission capacity in communication systems over single core optical fibers. In a multicore optical fiber, a plurality of cores are surrounded by a single cladding such that light propagates through each core. An all-glass process can be used to fabricate a multicore optical fiber, which uses a bulk cladding glass with one or more precision-formed axial holes. The holes each accommodate a core cane, and the core canes form the cores of the multicore optical fiber.

An all-glass process may be preferred over deposition-based processes (e.g., an outside vapor deposition (OVD) process) involving soot layering, sintering, and consolidation to convert the soot to glass. With an all-glass process, the cladding glass can be precision ground to a select diameter, which provides both the precision and flexibility of choosing a variety of spacings, shapes, and arrangements of the one or more axial holes when forming the glass preform. In some multicore optical fiber applications (e.g., submarine cables), the cores of the multicore optical fiber comprise alkali metals to obtain low attenuation in these fibers.

However, the all-glass process is relatively expensive and time consuming. The precision hole drilling takes time, the one or more core canes need to be formed to define a select refractive index profile and then added to the cladding glass, and the entire structure needs to be consolidated in a furnace to form the solid glass preform. To make the glass preform of sufficient length, it may be necessary to axially combine separate glass cladding sections, which involves precise alignment of the axial holes. Furthermore, such separate glass cladding sections are susceptible to formation of nucleation sites when heating the glass, which ultimately causes devitrification or crystallization in the multicore optical fiber preform and in the drawn optical fiber. Such devitrification or crystallization can make processing of the optical fiber glass preform difficult and/or increase attenuation in the optical fiber, which can result in lower glass yield or produce sub-optimal transmission properties in the optical fiber.

### SUMMARY OF THE DISCLOSURE

Alkali doped glass is especially vulnerable to the formation of nucleation sites since inclusion of the alkali dopant causes the glass to have a lower viscosity. Nucleation sites are locations of crystal formation on the glass. These sites can further grow and mature into crystallization or devitrification in the glass, which can spread through a significant portion of the glass or throughout the entirety of the glass. Once the devitrification has spread in the glass, it cannot be recovered and further downstream processing of the glass is not possible, and the glass must be discarded. Embodiments of the present disclosure are directed to processes for reducing and/or preventing the formation of crystallization or devitrification in alkali doped glass.

Aspects of the present disclosure comprise a method of making a multicore optical fiber preform, the method comprising consolidating a preform assembly to form the multicore optical fiber preform, the preform assembly comprising a plurality of core canes such that each core cane is disposed within an axial hole of a sleeve, each core cane comprising a core section comprised of alkali doped silica glass such that the silica glass has a maximum alkali concentration between about 0.10 wt. % and about 10 wt. %, the core section of each core cane being encased by the sleeve along a height of the core cane and by covers disposed at first and second axial ends of the core section, and the covers comprising silica glass having a chlorine concentration of about 0.05 wt. % or less.

Aspects of the present disclosure comprise a method of making a multicore optical fiber preform, the method comprising exposing the preform assembly to a treatment for a time t to form the multicore optical fiber preform, the preform assembly comprising a plurality of core canes such that each core cane is disposed within an axial hole of a sleeve, each core cane comprising a core section comprised of alkali doped silica glass such that the silica glass has a maximum alkali concentration between about 0.50 wt. % and about 10 wt. %, and the time t (sec) being such that: t<tc, and tc=10^{(1.86×10}^{^{−10}}^{T}^{⁴}^{-9.69×10}^{^{−7}}^{T}^{³}^{+1.91×10}^{^{−3}}^{T}^{²}^{-1.68T+571.9)} wherein tc is the time (sec) for the glass to crystalize to a volume fraction of 1 ppm and T is the exposure temperature (K).

Aspects of the present disclosure are directed to a multicore optical fiber preform comprising a plurality of core canes such that each core cane is disposed within an axial hole of a sleeve, each core cane comprising a core section comprised of alkali doped silica glass such that the silica glass has a maximum alkali concentration between about 0.10 wt. % and about 10 wt. %, the core section of each core cane being encased by the sleeve along a height of the core cane and by covers disposed at first and second axial ends of the core section, and the covers comprising silica glass having a chlorine concentration of about 0.05 wt. % or less.

Although many different embodiments are listed, the embodiments may exist individually or in any combination as possible. Hereinafter exemplary embodiments are shown and described.

### BRIEF DESCRIPTION OF THE DRAWINGS

FIG. 1 is a process to produce a multicore optical fiber, according to embodiments of the present disclosure;

FIG. 2 illustrates a sleeve with one or more axial through-holes, according to embodiments of the present disclosure;

FIGS. 3A and 3B illustrate a process of inserting core canes into a sleeve, according to embodiments of the present disclosure;

FIG. 4A illustrates a core cane with an alkali doped core, according to embodiments of the present disclosure;

FIG. 4B illustrates a cross-sectional view through line A-A of the core cane of FIG. 4A, according to embodiments of the present disclosure;

FIGS. 4C-4F illustrate covers disposed on ends of the alkali doped core, according to embodiments of the present disclosure;

FIGS. 5A and 5B illustrate a process of disposing a cover on an end of the alkali doped core, according to embodiments of the present disclosure;

FIG. 6 illustrates a preform assembly, according to embodiments of the present disclosure;

FIG. 7 illustrates a preform assembly within a draw tower furnace and connected to a vacuum system, according to embodiments of the present disclosure;

FIG. 8 depicts a plot of exposure temperature vs. nucleation formation rate, according to embodiments of the present disclosure;

FIG. 9 depicts a plot of exposure temperature vs. devitrification growth rate, according to embodiments of the present disclosure;

FIG. 10 depicts a plot of crystal volume fraction for glass doped with potassium at a concentration of 0.5 mol % (=0.78 wt. %) as a function of exposure temperature vs. exposure time, according to embodiments of the present disclosure;

FIG. 11 depicts a plot of crystal volume fraction for glass doped with potassium at a concentration of 1 mol % (=1.56 wt. %) as a function of exposure temperature vs. exposure time, according to embodiments of the present disclosure; and

FIG. 12 is a schematic diagram illustrating an exemplary drawing system, according to embodiments of the present disclosure.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

The expression “comprises” as used herein includes the term “consists of” as a special case, so that for example the expression “A comprises B and C” is understood to include the case of “A consists of B and C.”

The term “consolidated” as the term is used herein means taking an assembly made of different glass components that are not bonded to one another and heating the assembly so that the glass components can flow and bond or seal to each other to form a unified glass component that maintains the general overall configuration of the glass components, i.e., the glass components do not substantially change their basic shape.

The term “axial hole” or “axial through-hole” means a hole that runs parallel to the axial direction, i.e., parallel to a central axis or centerline.

The term “cylindrical” as used herein means a three-dimensional shape formed by taking a two-dimensional shape and projecting it along a third dimension perpendicular to the plane of the two-dimensional shape. Thus, a cylinder as the term is used herein can have cross-sectional shapes other than circular.

“Refractive index” refers to the refractive index at a wavelength of 1550 nm, unless otherwise specified.

The “refractive index profile” is the relationship between refractive index or relative refractive index and radius. For relative refractive index profiles depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When a relative refractive index varies with radial position in a particular region of the fiber (e.g. core region and/or any of the cladding regions), it is expressed in terms of its actual or approximate functional dependence, or its value at a particular position within the region, or in terms of an average value applicable to the region as a whole. Unless otherwise specified, if the relative refractive index of a region (e.g. core region and/or any of the cladding regions) is expressed as a single value or as a parameter (e.g. Δ or Δ %) applicable to the region as a whole, it is understood that the relative refractive index in the region is constant, or approximately constant, and corresponds to the single value, or that the single value or parameter represents an average value of a non-constant relative refractive index dependence with radial position in the region. For example, if “i” is a region of the glass fiber, the parameter Δᵢ refers to the average value of relative refractive index in the region as defined below, unless otherwise specified. Whether by design or a consequence of normal manufacturing variability, the dependence of relative refractive index on radial position may be sloped, curved, or otherwise non-constant.

“Relative refractive index,” as used herein, is defined by equation (1):

$${Δ}_{i} ( {r}_{i} ) \% = 100 \frac{( {n}_{i}^{2} - {n}_{ref}^{2} )}{2 {n}_{i}^{2}} \qquad ( 1 )$$

where nᵢ is the refractive index at radial position rᵢ in the glass fiber, unless otherwise specified, and n_{ref} is the refractive index of pure silica glass, unless otherwise specified. Accordingly, as used herein, the relative refractive index percent is relative to pure silica glass, which has a value of 1.444 at a wavelength of 1550 nm. As used herein, the relative refractive index is represented by Δ (or “delta”) or Δ % (or “delta %) and its values are given in units of “%”, unless otherwise specified. Relative refractive index may also be expressed as Δ(r) or Δ(r) %.

The average relative refractive index (Δₐᵥₑ) of a region of the fiber is determined from the following equation (2):

$${Δ}_{ave} = {\int }_{{r}_{inner}}^{{r}_{outer}} \frac{Δ ( r ) dr}{( {r}_{outer} - {r}_{inner} )} \qquad ( 2 )$$

where rᵢₙₙₑᵣ is the inner radius of the region, rₒᵤₜₑᵣ is the outer radius of the region, and Δ(r) is the relative refractive index of the region.

The refractive index of an optical fiber profile may be measured using commercially available devices, such as the IFA-100 Fiber Index Profiler (Interfiber Analysis LLC, Sharon, MA USA) or the S14 Refractive Index Profiler (Photon Kinetics, Inc., Beaverton, OR USA). These devices measure the refractive index relative to a measurement reference index, n(r)−nₘₑₐₛ, where the measurement reference index nₘₑₐₛ is typically a calibrated index matching oil or pure silica glass. The measurement wavelength may be 632.5 nm, 654 nm, 677.2 nm, 654 nm, 702.3 nm, 729.6 nm, 759.2 nm, 791.3 nm, 826.3 nm, 864.1 nm, 905.2 nm, 949.6 nm, 997.7 nm, 1050 nm, or any wavelength therebetween. The absolute refractive index n(r) is then used to calculate the relative refractive index as defined above.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

It is also important to note that the construction and arrangement of the elements of the disclosure, as shown in the exemplary embodiments, is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present disclosure. Other substitutions, modifications, changes, and omissions may be made in the design, operating conditions, and arrangement of the desired and other exemplary embodiments without departing from the spirit of the present disclosure.

Reference will now be made in detail to the present preferred embodiments of the disclosure, examples of which are illustrated in the accompanying drawings. Whenever possible, the same reference numbers will be used throughout the drawings to refer to the same or like parts.

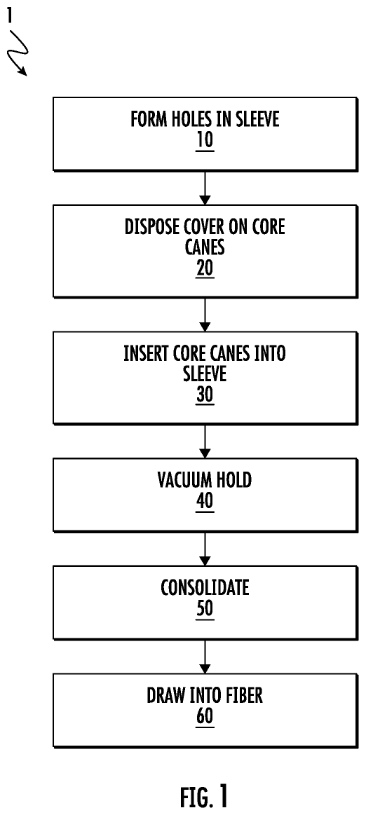

Referring now to FIG. 1, an exemplary process 1 is shown, according to embodiments of the present disclosure, to produce a multicore optical fiber. However, it is also contemplated that process 1 may be used to produce a single core optical fiber. As shown in FIG. 1, step 10 of process 1 comprises forming holes in a glass sleeve. The holes are each sized to accommodate a core cane. The core canes may comprise an alkali metal doped core. At step 20, a cover is disposed on the core canes in order to prevent devitrification of the core canes, as discussed below. In embodiments, the cover is welded to a core cane. At step 30 the core canes are inserted into the holes in the glass sleeve. A vacuum holding process is performed at step 40 followed by a consolidation process at step 50. During the consolidation of step 50, the fiber is heated in a consolidation furnace at an optimized temperature and exposure time as compared to a traditional consolidation step. A fiber is then drawn at step 60. In some embodiments, the drawn fiber is a submarine fiber. Each of the steps of process 1 are discussed further below in greater detail.

The core canes disclosed herein may comprise an alkali metal doped core. However, an alkali metal dopant causes glass to be more susceptible to devitrification when heating the glass at relatively high temperatures such as, for example, between about 730° C. and about 1630° C. (between about 1000 Kelvin (K) and about 1900 K). Devitrification is the process by which a glass changes structure and forms crystalline solids. These crystalline solids are undesirable in an optical fiber, as they form “hazy” flaws in the otherwise translucent glass, thus increasing Rayleigh scattering and attenuation in the glass. Significant fraction of devitrification can render the glass incapable of being processed downstream. Heating glass for too long at too high of a temperature can cause nucleation and growth of crystals, resulting in devitrification of the glass. Foreign matter can also cause the formation of nucleation sites on glass. Alkali doped glass is known to make the glass more susceptible to devitrification since it lowers the viscosity of the glass. By lowering the viscosity of the glass, nucleation sites are more prone to form when the glass is heated.

The alkali metal doped cores of the core canes disclosed herein are prone to formation of nucleation sites when the core canes are heated, such as during the vacuum hold of step 40 and/or the consolidation of step 50. Therefore, the alkali metal doped cores of the embodiments disclosed herein are capped with a cover in order to prevent and/or reduce the formation of nucleation sites. Furthermore, the core canes (with the alkali metal doped cores) are exposed to a heat treatment (e.g., consolidation step) with an optimized temperature and exposure time to also prevent and/or reduce devitrification of the glass. These embodiments are further disclosed below.

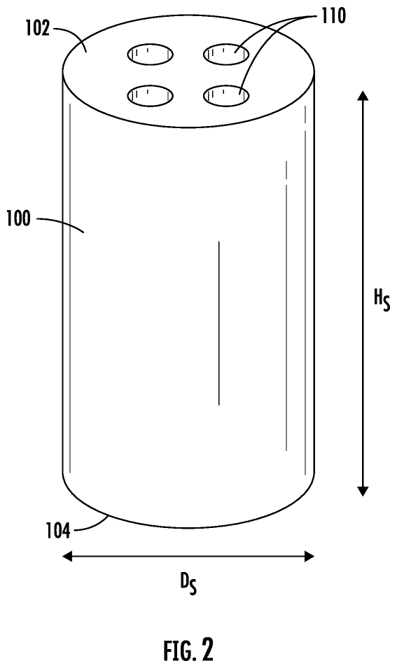

Referring again to process 1 and as shown in FIG. 2, holes 110 are formed in sleeve 100 at step 10. In some embodiments, holes 110 are formed by precision drilling such as, for example, diamond abrasive core drilling and/or ultrasonic assisted core drilling. Sleeve 100 is a cylindrical glass body that comprises a top surface 102 and a bottom surface 104. Furthermore, sleeve 100 is comprised of silica (e.g., pure silica or doped silica). As shown in FIG. 2, sleeve 100 has a diameter D_{S} and a height H_{S}. In some embodiments, the diameter D_{S} is in a range from about 25 mm to about 200 mm or from about 50 mm to about 125 mm and the height H_{S} is in a range from about 50 mm to about 2 m or from about 75 mm to about 1 m. In one exemplary embodiment, the diameter D_{S} is about 70 mm and the height H_{S} is about 110 mm. Other diameters and heights are contemplated as will be apparent to one skilled in the art.

Holes 110 are each an axial though-hole formed within an inner volume of sleeve 100. Although FIG. 2 shows four holes 110, it is also contemplated that sleeve 100 may comprise more or less holes 110. For example, sleeve 100 may comprise one or more holes, two or more holes, four or more holes, six or more holes, eight or more holes, ten or more holes, or twelve or more holes. Furthermore, holes 110 may have a circular cross-sectional shape, as shown in FIG. 2. It is also contemplated that holes 110 may comprise other cross-sectional shapes and that one or more holes may have a different cross-sectional shape from one or more other holes.

Holes 110 have an open, top end at top surface 102 of sleeve 100 and an open, bottom end at bottom surface 104 of sleeve 100. Thus, holes 110 each from a continuous opening from top surface 102 to bottom surface 104. In some embodiments, holes 110 each have a diameter from about 2 mm to about 60 mm, or about 5 mm to about 45 mm, or about 10 mm to about 30 mm. It is also contemplated that one or more holes 110 may have a different diameter from one or more other holes.

Holes 110 may be spaced equidistantly from each other. Furthermore, holes 110 may be arranged in any configuration and layout as is known in the art.

After formation of holes 110 in sleeve 100, one or more surfaces of sleeve 100 can be polished or finely ground. For example, an outer surface of sleeve 100 can be polished or finely ground to obtain a precise diameter D_{S} and/or a precise height H_{S}. Additionally or alternatively, the inner surfaces of holes 110 may be polished or finely ground. It also contemplated that top surface 102 and/or bottom surface 104 is polished or finely ground to obtain a precise flatness. In some embodiments, top and bottom surfaces 102, 104 are finely ground to obtain a surface roughness (RMS) of about 2 microns or less or about 1 micron or less.

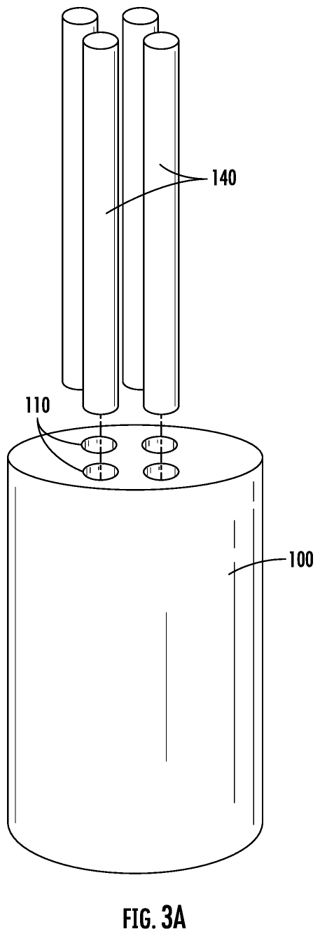

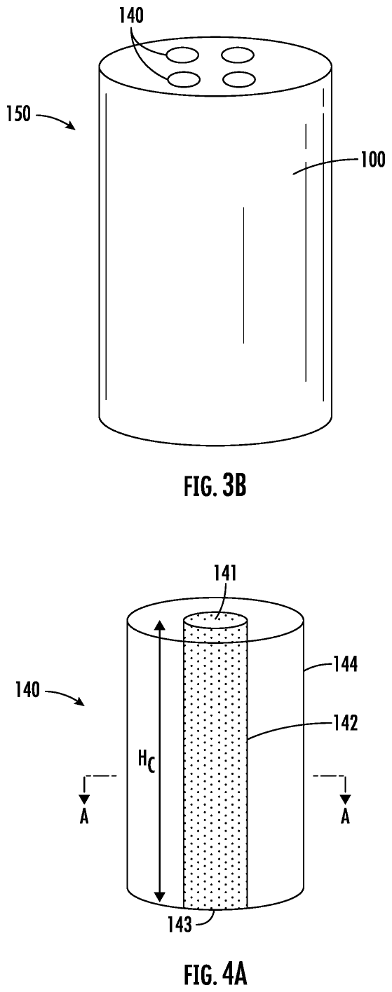

At step 20 of process 1, a cover is disposed on core canes (which is discussed further below). At step 30 of process 1, the core canes are inserted into holes 110 of sleeve 100. The cover may be disposed on the core canes either before or after the core canes are inserted into holes 110 of sleeve 100. Thus, in embodiments, step 20 of process 1 may be performed before or after step 30. FIG. 3A shows core canes 140 operably disposed relative to holes 110 of sleeve 100 in order to insert core canes 140 into sleeve 100. FIG. 3B shows core canes 140 positioned within holes 110 of sleeve 100, thus forming an exemplary assembled cane-cladding assembly 150. The cane-cladding assembly 150 is then connected to a nosecone and a handle to form a preform assembly.

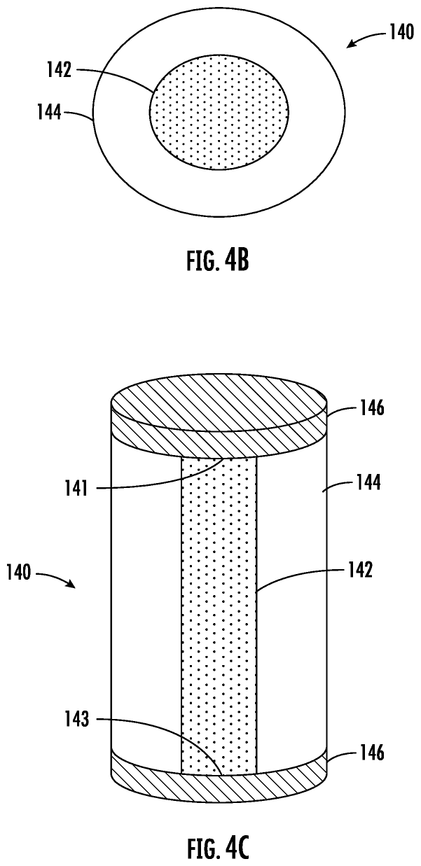

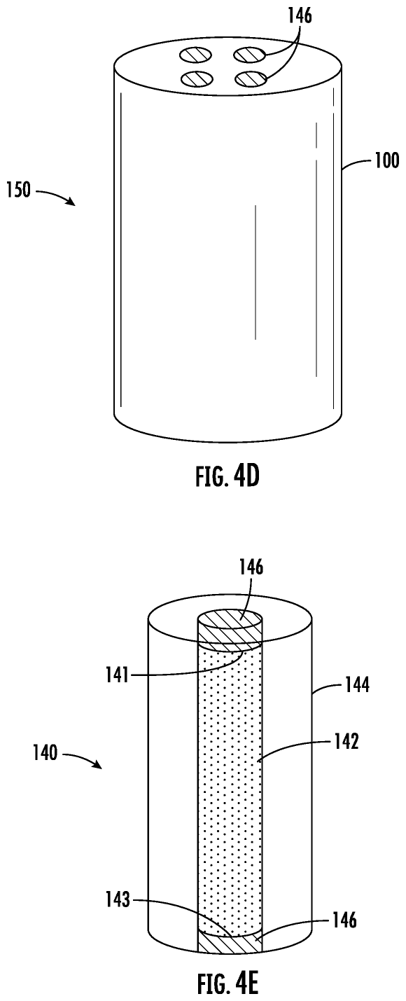

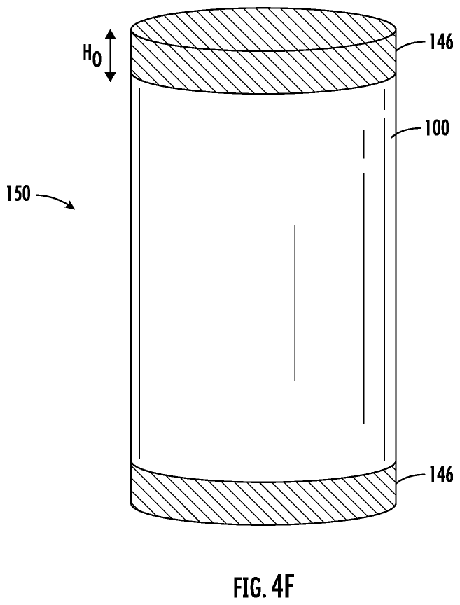

As shown in FIG. 4A, each core cane 140 is formed of a glass body that comprises a core section 142 surrounded by an inner cladding section 144. FIG. 4A shows the core cane before a cover is disposed on the peripheral ends of the core cane. And FIG. 4B shows a cross-sectional view of core cane 140 through line A-A of FIG. 4A. However, it is also contemplated in embodiments, that the glass body of core cane 140 may not comprise inner cladding section 144. In these embodiments, the glass body of core cane 140 consists of just core section 142.

In the final drawn optical fiber, produced by the processes disclosed herein, core section 142 forms a core in the fiber, inner cladding section 144 forms an inner cladding in the fiber, and sleeve 100 forms an outer cladding in the fiber.

Core section 142 may comprise up-doped silica glass and inner cladding section 144 may comprise up-doped silica glass, down-doped silica glass, or un-doped silica glass. Up-doped silica glass includes silica glass doped with, for example, germanium (e.g., GeO₂), phosphorus (e.g., P₂O₅), aluminum (e.g. Al₂O₃), chlorine (Cl), and/or an alkali metal, as discussed further below. In embodiments, core section 142 may have a higher refractive index than inner cladding section 144 and sleeve 100. Thus, the refractive index of core section 142 (Δ_{1,max} %), the refractive index of inner cladding section 144 (Δ₂%), and the refractive index of sleeve 100 (Δ₃%) follow the relations Δ_{1,max} %>Δ₂% and Δ_{1,max} %>Δ₃%. Furthermore, in some embodiments, Δ_{1,max}%>Δ₃%>Δ₂%. In some embodiments inner cladding section 144 has a discernible core-cladding boundary with core section 142 (in the drawn optical fiber). However, it is also contemplated that inner cladding section 144 can lack a distinct boundary with core section 142. Similarly, inner cladding section 144 may have a discernible core-cladding boundary with sleeve 100 or may lack a distinct boundary with sleeve 100 (in the drawn optical fiber). It is also contemplated that inner cladding section 144 may comprise one or more cladding portions having a different refractive index than one or more other portions of inner cladding section 144. For example, one or more portions of inner cladding section 144 may comprise a trench region (a depressed-index cladding region).

In embodiments disclosed herein, core section 142 may be doped with an alkali metal including, for example, potassium, sodium, rubidium lithium, cesium, or combinations thereof. The alkali metal dopant may be a metal oxide of these alkali metals, such as K₂O, Na₂O, Rb₂O, Li₂O, Cs₂O, or combinations thereof. Core section 142 may comprise one or more alkali metal dopants such that a maximum concentration of alkali metal dopants in core section 142 is between about 0.10 wt. % to about 10 wt. %, or about 0.25 wt. % to about 8 wt. %, or about 0.50 wt. % to about 10 wt. %, or about 0.50 wt. % to about 6 wt. %, or about 0.40 wt. % to about 5 wt. %, or about 0.75 wt. % to about 4 wt. %, or about 0.75 wt. % to about 5 wt. %, or about 0.78 wt. % to about 4 wt. %, or about 0.78 wt. % to about 5 wt. %, or about 1 wt. % to about 2 wt. %, or about 1.56 wt. % to about 6 wt. %, or about 1.56 wt. % to about 4 wt. %. Alkali concentrations below 0.10 wt. % do not sufficiently reduce attenuation in the drawn optical fiber. And alkali concentrations greater than 10 wt. % are not cost effective to produce. The maximum alkali concentrations disclosed herein are obtained at a centerline of core section 142. The concentration of the alkali metal dopant decreases radially outward from the centerline of core section 142 so that the concentration is highest at the centerline. Furthermore, the maximum alkali concentrations disclosed herein are obtained before the drawing of step 60 of process 1 and by Electron Probe Microanalysis (EPMA). For such EPMA measurements, core sections 142 are each polished and a conductive carbon coating is applied on the polish surface. The EPMA analyses are then performed on a JEOL 8500F Hyperprobe (2008) electron microprobe analyzer. Line scan analyses are performed using a focused beam and stepped at 1 micrometer step intervals across the diameter of each core section 142, transecting the core center. Typical beam parameters used for analyses are 15 keV accelerating potential at 50-100 nA beam current with on-peak count times ranging from 10-30 seconds.

Core section 142 may further comprise other dopants in addition to the alkali metal dopant. For example, core section 142 may comprise a halide dopant such as fluorine. In embodiments, only a radially central portion of core section 142 comprises the alkali metal dopant. Thus, radially outer portions of core section 142 do not comprise the alkali metal dopant. In these embodiments, the radially central portion of core section 142 (that comprises the alkali metal dopant) should not comprise chlorine or should only comprise minimal amounts of chlorine. For example, the radially central portion of core section may comprise about 0.05 wt. % or less of chlorine, or about 0.04 wt. % or less of chlorine, or about 0.03 wt. % or less of chlorine, or about 0.02 wt. % or less of chlorine, or about 0.01 wt. % or less of chlorine, or about 0.00 wt. % of chlorine. It is also noted that in these embodiments, the radially outer portions of core section 142 (that do not comprise the alkali metal dopant) may comprise greater amounts of chlorine.

It is also contemplated that inner cladding section 144 and/or sleeve 100 are doped with one or more dopants, such as a halide dopant. In some embodiments, the halide is fluorine.

As shown in FIG. 4A, the alkali metal doped core section 142 is radially surrounded by inner cladding section 144. More specifically, inner cladding section 144 surrounds core section 142 along a height H_{C} of core section 142. However, the first and second axial ends 141, 143 (i.e., top and bottom) of core section 142 are not surrounded by inner cladding section 144 and, therefore, are prone to devitrification when core section 142 is heated. As discussed above, the alkali metal doped core section 142 has a relatively lower viscosity so that nucleation sites are able to form when the glass is heated. With further heat treatment, the nucleation sites undergo crystal growth, contributing to crystallization and devitrification in the optical fiber preform and/or in drawn fiber. The inventors of the present disclosure found that such nucleation sites are more easily formed at the exposed portions of the alkali doped glass in comparison to the bulk of the glass. Therefore, with reference to FIG. 4A, when core cane 140 is heated to a high enough temperature, nucleation sites are prone to form at the exposed ends 141, 143 of core section 142 (which are not surrounded by inner cladding section 144). These nucleation sites mature into devitrification that penetrates throughout the entire glass structure. It is noted that nucleation sites are not prone to form along the height H_{C} of core section 142 as this portion of the glass is not exposed because it is encased by inner cladding section 144 (and by sleeve 100).

Embodiments of the present disclosure thus comprise capping ends 141, 143 of core section 142 with a cover 146 so that ends 141, 143 are no longer exposed when heating core cane 140. With such covers 146 disposed on ends 141, 143, the alkali doped core section 142 no longer has exposed portions that are prone to formation of nucleation sites. Therefore, the capped core section 142 can be heated without devitrification of the glass. As shown in FIG. 4A, a length (i.e., diameter) of ends 141, 143 is perpendicular to height H_{C} of core section 142. It is the length of ends 141, 143 that is capped with covers 146, in the embodiments disclosed herein.

More specifically, in the embodiments disclosed herein, covers 146 are disposed at least over ends 141, 143 of core sections 142. FIG. 4C shows an embodiment in which a cover 146 is disposed at both ends of core cane 140 so that they each cover an entire end of core cane 140. Therefore, each cover 146 is disposed over an end 141, 143 of core section 142 along with an end of inner cladding section 144. In this embodiment, covers 146 form endcaps that sandwich core section 142 and inner cladding section 144. Furthermore, in the embodiment of FIG. 4C, covers 146 are in direct contact with both core section 142 and inner cladding section 144. As disclosed herein, covers 146 are each a devitrification inhibitor that prevents devitrification with the glass. Covers 146 may also be referred to herein as endcaps, barriers, bodies, blocking bodies, or barricades. It is noted that with covers 146 at ends 141, 143 of core section 142 and with inner cladding section 144 covering core section 142 along the height H_{C}, core section 142 is completely encased and enclosed by the glass of covers 146 and inner cladding section 144.

Covers 146 may be comprised of up-doped silica glass, down-doped silica glass, or un-doped silica glass. More specifically, covers 146 may comprise the same materials as those disclosed above for core section 142, inner cladding section 144, and/or sleeve 100. However, covers 146 should each comprise about 0.05 wt. % or less of chlorine, or about 0.04 wt. % or less of chlorine, or about 0.03 wt. % or less of chlorine, or about 0.02 wt. % or less of chlorine, or about 0.01 wt. % or less of chlorine, or about 0.00 wt. % of chlorine. The alkali dopant (e.g., potassium) in core section 142 reacts with chlorine to form, for example, potassium chloride (KCl), which forms cristobalites in the produced preform. Such a preform cannot be drawn into an optical fiber and, instead, is discarded. Therefore, covers 146 should be free or essentially free of chlorine in order to prevent the formation of potassium chloride. In some embodiments, covers 146 are doped with fluorine such that covers 146 have a fluorine concentration from about 0.0 wt. % to about 2.0 wt. %, or about 0.1 wt. % to about 1.8 wt. %, or about 0.2 wt. % to about 1.6 wt. %, or about 0.5 wt. % to about 1.4 wt. %, or about 0.8 wt. % to about 1.2 wt. %, or about 1.0 wt. % to about 1.5 wt. %. In embodiments, the fluorine concentration in covers 146 is chosen so that the viscosity of covers 146 is the substantially the same as the viscosity of core section 142.

FIG. 4D shows core canes 140, with covers 146 disposed on the ends thereof, inserted into sleeve 100 to form the core-cladding assembly 150. In the embodiment of FIG. 4D, covers 146 are disposed over the ends of both core section 142 and inner cladding section 144 (as shown in FIG. 4C).

FIG. 4E shows a second embodiment in which covers 146 are disposed on ends 141, 143 of core section 142. However, in this embodiment, covers 146 are not disposed on the ends of inner cladding section 144. In this embodiment, covers 146 form endcaps that sandwich core section 142. Furthermore, in the embodiment of FIG. 4E, covers 146 are in direct contact with core section 142 and inner cladding section 144 is exposed at the ends of core cane 140.

It is noted that in the embodiment of FIG. 4E, covers 146 are disposed over the entirety of each of ends 141, 143. In some other embodiments, covers 146 may be disposed over less than the entirety of each of ends 141, 143 as long as covers 146 are disposed over the alkali-containing portion of ends 141, 143. As discussed above, in some embodiments, only a radially central portion of core section 142 comprises the alkali metal dopant and radially outer portions of core section 142 do not comprise the alkali metal dopant. Therefore, it is contemplated that covers 146 are disposed on the radially central portion of ends 141, 143 but not the radially outer portions of ends 141, 143.

FIG. 4F shows yet another embodiment in which covers 146 are disposed not only on the ends of core section 142 and inner cladding section 144, but also over the ends of sleeve 100. Thus, covers 146 are disposed over the entire ends of core-cladding assembly 150. In the embodiment of FIG. 4F, covers 146 are in direct contact with core section 142, inner cladding section 144, and sleeve 100.

Covers 146 may each have a height Ho (as shown in FIG. 4F) of about 0.1 mm or greater, or about 0.2 mm or greater, or about 0.3 mm or greater, or about 0.4 mm or greater, or about 0.5 mm or greater, or about 0.6 mm or greater, or about 0.7 mm or greater, or about 0.8 mm or greater, or about 0.9 mm or greater, or about 1.0 mm or greater, or about 0.1 mm to about 1.0 mm, or about 0.2 mm to about 0.9 mm, or about 0.3 mm to about 0.8 mm, or about 0.4 mm to about 0.7 mm, or about 0.5 mm to about 0.6 mm. Although the height Ho is referenced with regard to FIG. 4F, it is noted that any of the embodiments disclosed herein may comprise covers 146 with these disclosed heights.

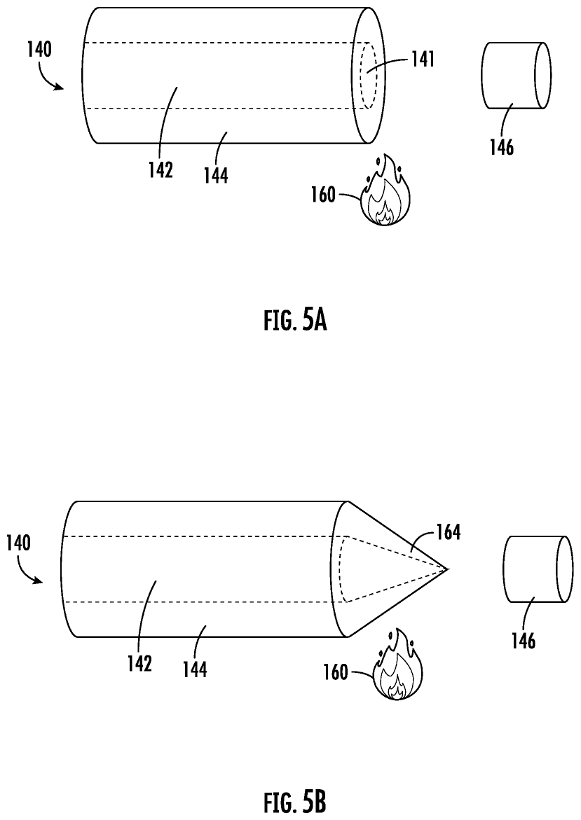

FIG. 5A shows a process of attaching a cover 146 to an end of core cane 140. In this example, cover 146 is attached to end 141 of core section 142. In the embodiments disclosed herein, the core cane 140 and cover 146 are heated by a flame 160 and then the core cane 140 and cover 146 are brought into contact to weld and/or fuse the two components together. As shown in FIG. 5B, in some embodiments, the core cane 140 is first heated to create a projecting tip 164 on the core cane 140, which helps to adhere the components together. When joining covers 146 to core cane 140, it is important to keep the temperature of core cane 140 so that it is equal to or higher than the melting point of cristobalites (which is about 1700° C.) in order to maintain stability of the glass so that the glass does not bend to one side or another. In some preferred embodiments, the temperature is maintained at a temperature of at least about 1800° C., or at least about 1900° C., or at least about 2000° C., or at least about 2100° C., or at least about 2200° C., or at least about 2300° C., or at least about 2400° C., or at least about 2500° C. The maximum temperature of the core cane 140 (when joining the core cane 140 to a cover 146) should be about 3000° C., or about 2900° C., or about 2800° C., or about 2700° C., or about 2600° C. It is also noted that a similar welding and/or fusion process may be used to attach cover 146 to inner cladding section 144 and sleeve 100 in the embodiments where cover 146 extends beyond just the border of core section 142 at the peripheral ends.

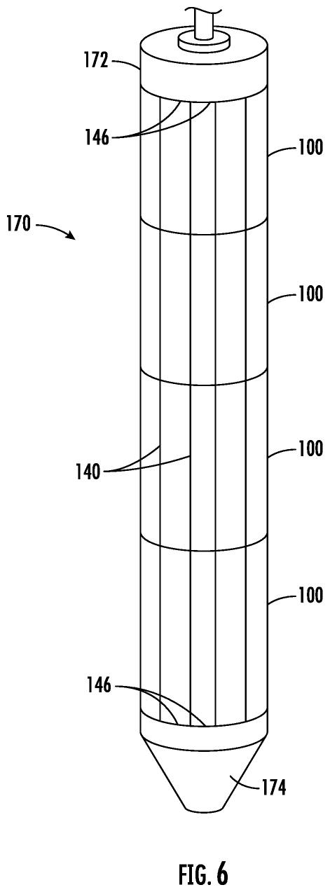

Once core canes 140 (with covers 146 disposed thereon) are inserted into holes 110 of sleeve 100 to form cane-cladding assembly 150, a nosecone and a handle are connected to the assembly to form a preform assembly. FIG. 6 shows an assembled preform assembly 170 that comprises a plurality of stacked sleeves 100. In the exemplary embodiment of FIG. 6, preform assembly 170 comprises four sleeves 100. However, it is noted that preform assembly 170 may comprise just one sleeve 100. In the embodiments with multiple sleeves 100, each core cane 140 extends for the length of the combined multiple sleeves. Therefore, each core cane 140 is disposed within the axial holes of each stacked sleeve 100. In these embodiments with the multiple sleeves 100, covers 146 are still disposed at the ends of the core canes 140.

Furthermore, preform assembly 170 comprises a handle 172 and a nosecone 174, which are each formed of glass. As discussed further below, these components are held together during the vacuum holding process (step 40 of process 1). When in the stacked formation, such as shown in FIG. 6, handle 172 is disposed vertically above sleeve(s) 100 and sleeve(s) 100 are disposed vertically above nosecone 174. As shown in FIG. 6, when in the stacked formation, handle 172 is in direct contact with the top-most sleeve 100 and each sleeve 100 is in direct contact with an adjacent sleeve 100. Furthermore, the bottom-most sleeve 100 is in direct contact with nosecone 174. It is also noted that the top-most cover 146 is in direct contact with handle 172 and that the bottom-most cover 146 is in direct contact with nosecone 174. Handle 172, sleeve(s) 100, and nosecone 174 are cleaned (e.g., acid washed and then rinsed with deionized water) before being assembled into the stacked formation.

As discussed further below, handle 172 and nosecone 174 are held together with sleeve(s) 100 using vacuum pressure. While handle 172 and nosecone 174 are secured to sleeve(s) 100 with the vacuum pressure, these components are not sealed together. Because these components are not sealed together, ends 141, 143 of core sections 142 are still exposed to the surrounding atmosphere such that the alkali doped core sections 142 are prone to formation of nucleation sites when the glass is heated. Therefore, covers 146 are disposed on the alkali doped core sections 142 to prevent the formation of the nucleation sites (as discussed above).

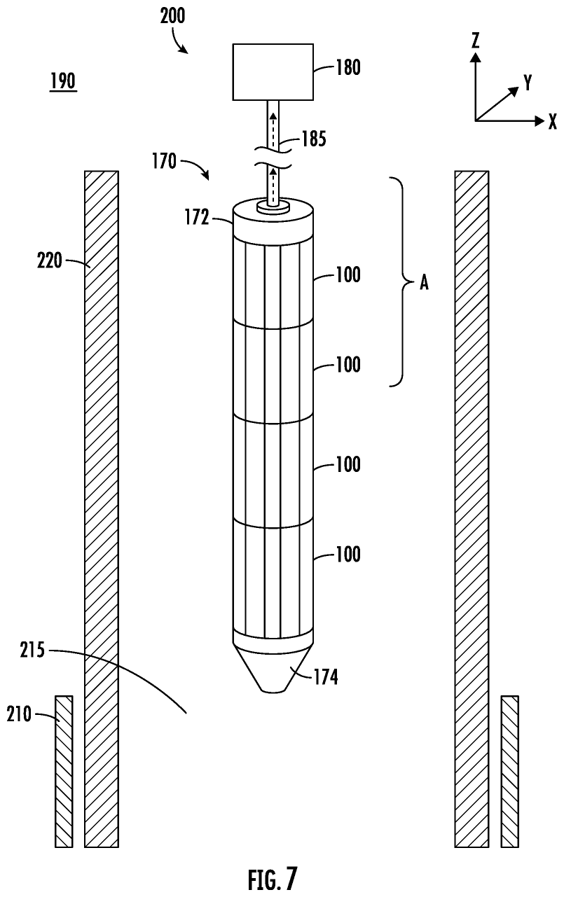

As also shown in FIG. 7, the stacked preform assembly 170 is connected to a vacuum system 180, such that the stacked preform assembly 170 and vacuum system 180 together comprise a preform system 200. Vacuum system 180 further comprises a conduit 185 that supports preform assembly 170 and provides an air flow connection between vacuum system 180 and preform assembly 170. As discussed further below, vacuum system 180 uses pneumatic pressure to hold handle 172, sleeve(s) 100, and nosecone 174 together when in the stacked formation of preform assembly 170.

When activated, vacuum system 180 pulls air from channels within sleeve(s) 100 (which are formed by gaps between core canes 140 and sleeve 100) and into vacuum system 180. The vacuum pull creates a substantial pressure differential ΔP between the channels and the ambient environment 190 surrounding preform system 200. This pressure differential ΔP causes handle 172, sleeve(s) 100, and nosecone 174 to be held together when oriented vertically in the stacked formation. Thus, these components are held together against the force of gravity. In an example, the pressure differential ΔP between vacuum system 180 and normal ambient pressure at sea level provides an axial compressive force of 98.5 kg on a typical assembly in which sleeves 100 have a diameter D_{S} of 122 mm. In other embodiments, the pressure differential ΔP can be on the order of about 100 kg, with the exact value depending on the weight of the various components of preform assembly 200, as will be apparent to one skilled in the art. The vacuum pull of vacuum system 180 forms a vacuum-held-together (“vacuum-held”) preform assembly 170.

After the vacuum holding process of step 40 of process 1, preform assembly 170 may be consolidated in a consolidation furnace (step 50 of process 1). In some embodiments, preform assembly 170 is consolidated in the same furnace where the above-disclosed vacuum holding process was performed. In yet some further embodiments, this same furnace is also used to draw the preform into an optical fiber. Therefore, in these embodiments, the consolidation furnace is also a draw tower furnace. It is noted that the consolidation of step 50 is performed after covers 146 have been welded/fused to ends 141, 143 of core section 142. Because the glass of preform assembly 170 is heated during the consolidation of step 50, covers 146 are needed to prevent the formation of nucleation sites on the alkali doped core sections 142.

In addition to providing covers 146 on core sections 142 to prevent the formation of nucleation sites, the temperature and time duration of the consolidation of step 50 and in downstream processing of the preform is optimized to prevent devitrification in the optical fiber preform and/or in the drawn optical fiber. It is noted that even with covers 146 disposed on the alkali doped core sections 142, devitrification can still form in the bulk of the glass if the glass is heated at a high enough temperature for a sufficient amount of time. Therefore, embodiments of the present disclosure comprise not only positioning covers 146 on the ends of the core sections 142 (to prevent formation of nucleation sites at exposed ends of the glass), but also managing and optimizing the consolidation and exposure heating conditions (to reduce and/or prevent devitrification growth in the bulk of the glass). In order to manage and optimize the consolidation and exposure heating conditions, the inventors of the present disclosure discovered the relationship between crystal nucleation and growth (within alkali doped glass) and temperature of the glass, the crystallization rate being a function of both nucleation formation rate and devitrification growth rate of the alkali doped glass. By determining this relationship, the inventors of the present disclosure were then able to optimize this relationship to prevent and/or reduce crystal growth, as discussed below.

In order to determine the optimized relationship between crystallization rate and temperature, the relationship between nucleation formation rate and glass temperature was first determined. This relationship is shown in equation (3):

$$I = \frac{{A}_{C} T}{η} exp [ - \frac{W *}{kT} ] \qquad ( 3 )$$

where I is the nucleation formation rate (cm⁻³/sec), T is the exposure temperature (K) of the glass (e.g., consolidation temperature), q is the viscosity of the alkali doped glass (Poise) as defined below, W* is the thermodynamic free energy barrier to nucleation (calories) as defined below, and k is the Boltzmann constant (which is 3.297×10⁻²⁴ cal·K⁻¹). In equation (3) above, the parameter A_{C} is given by equation (4):

$${A}_{C} = \frac{{N}_{v} {k}_{B}}{3 π {λ}^{3}} \qquad ( 4 )$$

where Nᵥ is the number of atoms of the crystallizing component phase per unit volume of liquid (number of atoms/cm³), which corresponds to the number of sites available for nucleation to take place within the glass. In equation (4), k_{B} is the Boltzmann constant having units of cm² g s⁻² K⁻¹ (which is 1.3807×10⁻¹⁶ cm² g s⁻² K⁻¹) and k is the characteristic jump distance that correlates diffusivity to the liquid viscosity through the Stokes-Einstein relation (cm).

The thermodynamic free energy barrier to nucleation W* of equation (3) above is the barrier in a glass to nucleation formation in the glass. Therefore, the higher the W*, the less prone the glass is to nucleation formation. The value of W* is calculated using equation (5):

$$W *= \frac{16 π {σ}^{3} {V}_{m}^{2}}{3 {( Δ G )}^{2}} \qquad ( 5 )$$

where σ is the crystal-liquid surface tension or interfacial free energy per unit area (cal/cm) and Vₘ is the molar volume of the crystal phase of the glass (cm³), which is the volume of one mole of crystal glass. In equation (5), ΔG is the bulk free energy change per mole, which is calculated using equation (6):

$$Δ G = - Δ {H}_{f} ( 1 - ( \frac{T}{{T}_{m}} ) ) \qquad ( 6 )$$

where ΔH_{f} is the heat of fusion (cal/g-atom), which is the amount of heat required to melt a single crystal. In equation (6), T is the exposure temperature (K) of the glass (e.g., the consolidation temperature) and Tₘ is the melting temperature of the glass (K). In the embodiments disclosed herein, Tₘ is 1986 K, ΔH_{f} is 2415 cal/g-atom, Vₘ is 27.27 cm³, and k is 2.5 angstroms.

The viscosity η of the alkali doped glass of equation (3) above is calculated using equation (7):

$${log}_{10} η = A + \frac{B}{T} \qquad ( 7 )$$

where parameters A and B are each a function of the alkali mole percent K in the glass, as follows:

$$A = - 5.965 + 1.0294 K - 0.09847 {K}^{2} , K \leq 6.3$$

$$A = - 3.8785 + 0.10322 K - 0.0050651 {K}^{2} + 4.6184 e - 5 {K}^{3} , K > 6.3$$

$$B = 26 \; 315 - 7359.5 K + 1173.1 {K}^{2} - 57.855 {K}^{3} , K \leq 2.5$$

$$B = 16 \; 080 - 803.23 K + 32.641 {K}^{2} - 0.41516 {K}^{3} , K > 2.5$$

Using equation (3) above, the inventors of the present disclosure plotted the nucleation formation rate vs. temperature for glass doped with varying amounts of alkali, as shown in FIG. 8. More specifically, the plots of FIG. 8 include glass doped with 1 mol % (=1.56 wt. %) of potassium, 0.5 mol % (=0.78 wt. %) of potassium, and 0 mol % of potassium. As shown in FIG. 8, the nucleation formation rate in the glass is at a maximum at about 1350 K (1077° C.) and decreases as the temperature of the glass increases or decreases from 1350 K. Furthermore, as shown in FIG. 8, the nucleation formation rate increases as the potassium concentration increases in the glass. This again supports the conclusion that alkali doped glass is more prone to nucleation formation than undoped glass due to the reduced viscosity of the alkali doped glass.

In order to determine the optimized relationship between crystal growth and temperature (as discussed above), the relationship between devitrification growth rate and glass temperature was also determined. This relationship is shown by equation (8):

$$u = \frac{k T}{3 π η {λ}^{2}} [ 1 - exp ( - \frac{Δ G}{R T} ) ] \qquad ( 8 )$$

where u is the devitrification growth rate (cm/sec), k is the Boltzmann constant as discussed above with regard to equation (3), T is the exposure temperature (K) as discussed above, η is the viscosity of the glass (Poise) as discussed above, λ is the characteristic jump distance that correlates diffusivity to the liquid viscosity through the Stokes-Einstein relation (angstroms) as discussed above, ΔG is the bulk free energy change per mole as discussed above, and R is the universal gas constant.

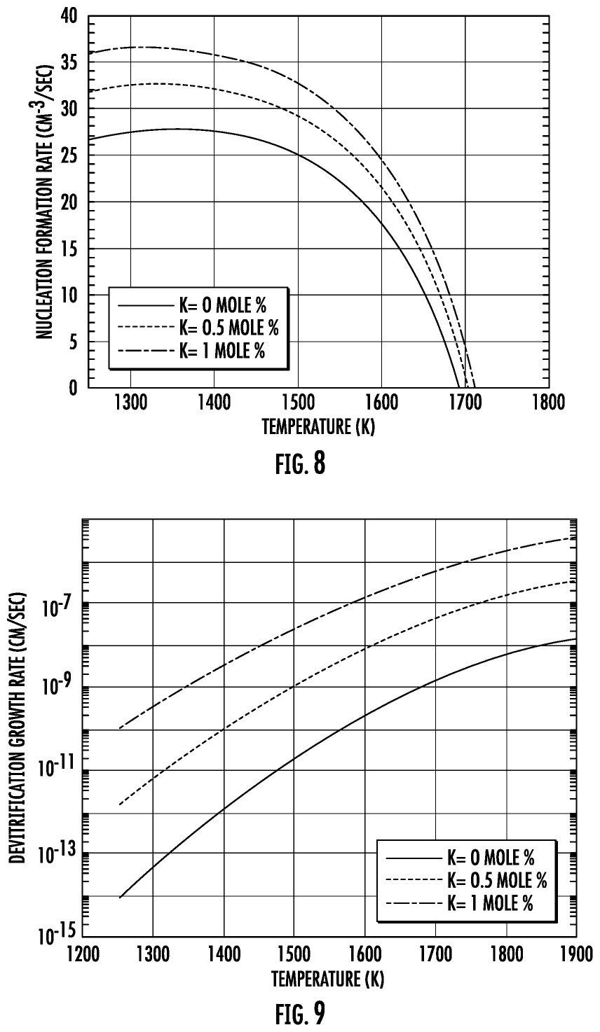

Using equation (8) above, the inventors of the present disclosure plotted the devitrification growth rate vs. temperature for glass doped with varying amounts of alkali, as shown in FIG. 9. More specifically, the plots of FIG. 9 include glass doped with 1 mol % (=1.56 wt. %) of potassium, 0.5 mol % (=0.78 wt. %) of potassium, and 0 mol % of potassium. As shown in FIG. 9, the devitrification growth rate in the glass increases as the temperature of the glass increases. It is noted that, although not shown in FIG. 9, the devitrification growth rate in the glass only increases as the temperature increases up to the glass liquidus temperature, beyond which the growth rate is zero. Furthermore, as shown in FIG. 9, the devitrification growth rate increases as the potassium concentration increases.

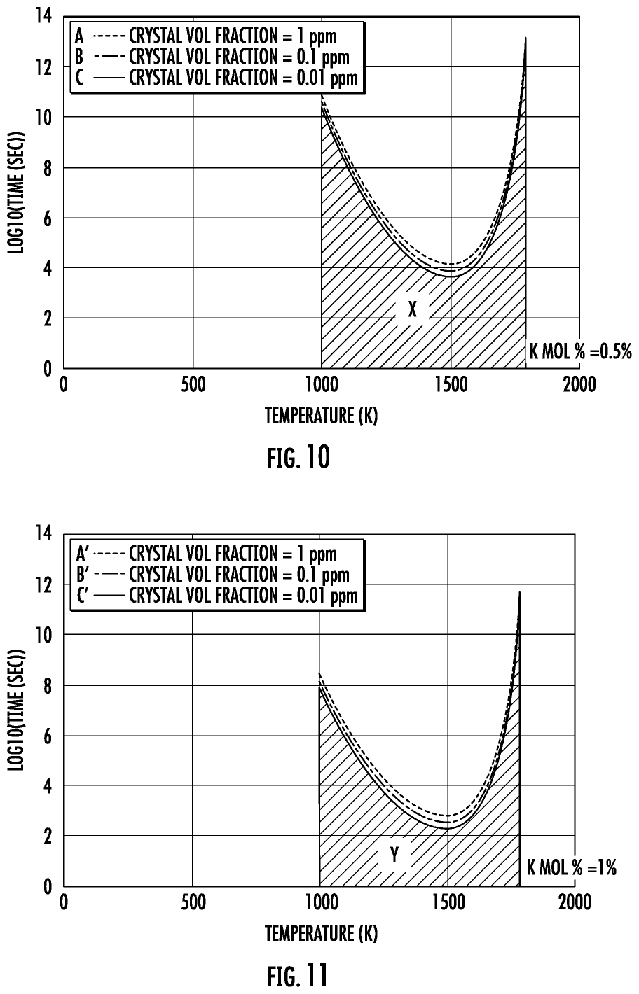

When comparing FIG. 8 with FIG. 9, the nucleation formation rate in FIG. 8 decreases as the temperature increases, thus favoring higher temperatures to reduce nucleation formation. However, the devitrification growth rate of FIG. 9 increases as the temperature increases, thus favoring lower temperatures to reduce devitrification growth. The inventors of the present disclosure thus discovered optimized exposure temperatures to reduce the overall crystallization rate, which depends on both nucleation formation rate and devitrification growth rate, as explained below with reference to equations (9) and (10) and FIGS. 10 and 11.

Equation (9) below provides a calculation for overall crystal growth as a function of both nucleation formation rate and devitrification growth rate of the alkali doped glass and is provided as:

$$X = \frac{1}{3} π I {u}^{3} {t}^{4} \qquad ( 9 )$$

where X is the crystal volume fraction (i.e., volume fraction of crystalline phase in the glass) at a time t (sec), I is the nucleation formation rate (cm³/sec) as calculated using equation (3) above, and u is the devitrification growth rate (cm/sec) as calculated using equation (8) above. It is noted that the crystal volume fraction X of equation (9) is measured throughout the bulk of the glass. The above equation (9) is used for a specific or constant temperature. When the temperature varies during the heating of the glass, the growth rate can be calculated using equation (10):

$$X = 1 - Exp [ - \frac{π}{3} {\int }_{0}^{t} ( {\{ {\int }_{0}^{t} {udt}^{′} \}}^{3} I ) {dt}^{″} ] \qquad ( 10 )$$

The above-disclosed nucleation formation rate and devitrification growth rate calculations to derive the disclosed crystal volume fraction are further disclosed in the following references, each of which is incorporated by reference herein: D. R. Uhlmann, ‘A Kinetic Treatment of Glass Formation,’ Journal of Non-Crystalline Solids, vol. 7, pg. 337-348 (1972); Chih-Yao Fang, ‘A Kinetic Treatment of Glass Formation. VIII: Critical cooling rates for Na₂O—SiO₂ and K₂O—SiO₂ glasses,’ Journal of Non-Crystalline Solids, vol. 7, pg. 465-471 (1983); Kazumasa Matusita, ‘Rate of Homogeneous Nucleation in Alkali Disilicate Glasses,’ Journal of Non-Crystalline Solids, vol. 11, pg. 471-484 (1973); and Michael C. Weinberg, ‘Critical Cooling Rate Calculations for Glass Formation,’ Journal of Non-Crystalline Solids, vol. 123, pg. 90-96 (1990).

FIG. 10 is a Time-Temperature Transformation (TTT) plot showing curves of the crystal volume fraction of silica glass doped with potassium at a concentration of 0.5 mol % (=0.78 wt. %) potassium. The crystal volume fraction values in FIG. 10 were calculated using equation (9) above, and the modeled crystal volume fraction curves in FIG. 10 are plotted as a function of exposure time vs. exposure temperature. In particular, FIG. 10 shows the combination of exposure temperature and time corresponding to three crystal volume curves (A, B, and C), each with a different crystallization volume fraction. Curves A, B, and C in FIG. 10 each show the least time required for the given volume fraction to crystalize as a function of exposure temperature.

The inventors of the present disclosure discovered that in order to achieve a crystal volume fraction below a threshold crystal volume fraction, which could result in unacceptable attenuation increase or negatively impact the downstream processing of the glass, the exposure temperature and exposure time must be below the desired curve shown in FIG. 10. More specifically, curves A, B, and C of FIG. 10 each represent a threshold crystal volume fraction. In order to produce glass that has a crystal volume fraction of one of these curves or less than, the exposure temperature and exposure time must be below that specific curve. For example, in order to achieve a desired crystal volume fraction of 0.01 ppm (curve C) or less in consolidated silica glass doped with 0.5 mol % (=0.78 wt. %) of potassium, the consolidation temperature and exposure time must be below curve C, which is within area X. Therefore, area X provides the exposure times and corresponding exposure temperatures to achieve a volume fraction of crystallization below the desired threshold of 0.01 ppm in silica glass doped with 0.5 mol. % (=0.78 wt. %) potassium. It is noted that any of the corresponding exposure times and temperatures that fall within area X should achieve the desired volume fraction of crystallization or less of curve C. As also shown in FIG. 10, area X falls within the temperatures of about 1000 K (about 730° C.) and about 1925 K (about 1652° C.), in embodiments.

Furthermore, as discussed above, the overall crystal volume fraction in the glass depends on both crystal nucleation formation and devitrification growth rate. As shown in FIG. 10, the combined effect of nucleation formation and devitrification growth magnifies at an exposure temperature of about 1550 K (1277° C.), which is the temperature corresponding to the smallest exposure time to reach the desired crystal volume fraction. Therefore, the exposure temperature of about 1550 K requires the most stringent exposure times to reach the desired crystal volume fraction. The process is more forgiving with regard to exposure times at temperatures above or below 1550 K.

The inventors of the present disclosure further calculated that, based upon the results of FIG. 10, the exposure treatment time for potassium doped glass having a concentration of 0.5 mol % (=0.78 wt. %) potassium can be calculated using equation (11) below. It is noted that equation (11) is the best-fit curve of the cumulation of curves A, B, and C. It is also noted that the exposure treatment time calculated using equation (11) below applies to heat treatment of the glass to produce glass below the threshold crystal volume fraction. The exposure treatment may be, for example, the consolidation of step 50 or the vacuum hold of step 40 of process 1. Equation (11) is provided as:

$$tc = 10 \hat{} ( 1.86 \times {10}^{- 10} {T}^{4} - 9 \text{.69} \times {10}^{- 7} {T}^{3} + 1 \text{.91} \times {10}^{- 3} {T}^{2} - 1.68 T + 571.9 ) \qquad ( 11 )$$

wherein tc is the time (sec) for the glass to crystalize to a volume fraction of 1 ppm and T is the exposure temperature (K). In order to achieve a crystal volume fraction below the threshold of 1 ppm, the exposure time (t) of the glass must be below tc (such that t<tc). Therefore, for example, when heating the glass during the consolidation of step 50 of process 1, the consolidation exposure time must be below the time tc. In embodiments, the best-fit curve of equation 11 is between the temperatures of about 1000 K (about 730° C.) and about 1925 K (about 1652° C.).

FIG. 11 is a Time-Temperature Transformation (TTT) plot showing curves of the crystal volume fraction of silica glass doped with potassium at a concentration of 1 mol % (=1.56 wt. %) potassium. The crystal volume fraction values in FIG. 11 were calculated using equation (9) above, and the modeled crystal volume fraction curves in FIG. 11 are plotted as a function of exposure time vs. exposure temperature. FIG. 11 shows the combination of exposure temperature and time corresponding to three crystal volume curves (A′, B′, C′), each with a different crystallization volume fraction. Curves A′, B′, and C′ in FIG. 11 each show the least exposure time required for the given volume fraction to crystallize as a function of exposure temperature.

The inventors of the present disclosure discovered that in order to achieve a desired crystal volume fraction below a threshold crystal volume fraction, which could result in unacceptable attenuation increase or negatively impact the downstream processing of the glass, the exposure temperature and exposure time must be below the desired curve shown in FIG. 11. More specifically, curves A′, B′, and C′ of FIG. 11 each represent a threshold crystal volume fraction. In order to produce glass that has a crystal volume fraction of one of these curves or less than, the exposure temperature and exposure time must be below that specific curve. For example, in order to achieve a desired crystal volume fraction of 0.01 ppm (curve C′) or less in consolidated silica glass doped with 1 mol % (=1.56 wt. %) of potassium, the consolidation temperature and exposure time must be below plot curve C′, which is within area Y. Therefore, area Y provides the exposure times and corresponding exposure temperatures to achieve the desired crystal volume fraction of 0.01 ppm or less in silica glass doped with 1 mol. % (=1.56 wt. %) potassium. It is noted that any of the corresponding exposure times and temperatures that fall within area Y should achieve the desired crystal volume fraction or less of curve C′. As also shown in FIG. 11, area Y falls within the temperatures of about 1000 K (about 730° C.) and about 1925 K (about 1652° C.), in embodiments.

Furthermore, as discussed above, the overall crystal volume fraction in the glass depends on both crystal nucleation formation and devitrification growth rate. As shown in FIG. 11, the combined effect of nucleation formation and devitrification growth magnifies at an exposure temperature of about 1550 K (1277° C.), which is the temperature corresponding to the smallest exposure time to reach the desired crystal volume fraction. Therefore, the exposure temperature of about 1550 K requires the most stringent exposure times to reach the desired crystal volume fraction. The process is more forgiving with regard to exposure times at temperatures above or below 1550 K.

The inventors of the present disclosure further calculated that, based upon the results of FIG. 11, the consolidation exposure time for potassium doped glass having a concentration of 1 mol % (=1.56 wt. %) potassium can be calculated using equation (12) below. It is noted that equation (12) is the best-fit curve of the cumulation of curves A′, B′, and C′. It is also noted that the exposure treatment time calculated using equation (12) below applies to heat treatment of the glass to produce glass below the threshold crystal volume fraction. The exposure treatment may be, for example, the consolidation of step 50 or the vacuum hold of step 40 of process 1. Equation (12) is provided as:

$$tc = 10 \hat{} ( 1.67 \times {10}^{- 10} {T}^{4} - 8 \text{.68} \times {10}^{- 7} {T}^{3} + 1.7 \times {10}^{- 3} {T}^{2} - 1.5 T + 506 ) \qquad ( 12 )$$

wherein tc is the time (sec) for the glass to crystalize to a volume fraction of 1 ppm and T is the exposure temperature (K). In order to achieve a crystal volume fraction below the threshold of 1 ppm, the exposure time (t) of the glass must be below tc (such that t<tc). Therefore, for example, when heating the glass during the consolidation of step 50 of process 1, the consolidation exposure time must be below the time tc. In embodiments, the best-fit curve of equation 12 is between the temperatures of about 1000 K (about 730° C.) and about 1925 K (about 1625° C.).

When comparing FIGS. 10 and 11, it is noted that curves A′, B′, and C′ of FIG. 11 with the relatively higher concentration of potassium of 1 mol % (=1.56 wt. %) have stricter exposure times at the same corresponding exposure temperatures than curves A, B, and C of FIG. 10 with the relatively lower concentration of potassium of 0.5 mol % (=0.78 wt. %). Therefore, meeting the exposure times and exposure temperatures of curves A′, B′, and C′ of FIG. 11 not only achieves the crystal volume fraction in silica glass below the threshold crystal volume fraction with 1 mol % (=1.56 wt. %) potassium but also in silica glass with 0.5 mol % potassium (=0.78 wt. %). More specifically, the exposure times and temperatures of curves A′, B′, and C′ will achieve the desired crystal volume fraction in silica glass with between 0.5 mol % (=0.78 wt. %) to 1 mol % (=1.56 wt. %) potassium. Stated another way, the exposure time (t) should be below the time (tc) (t<tc) for the glass to crystalize to a volume fraction of 1 ppm, as discussed above with reference to equation 12, to achieve the desired crystal volume fraction in silica glass with between 0.5 mol % (=0.78 wt. %) to 1 mol. % (=0.78 wt. %) potassium.

With reference again to FIG. 7, in embodiments disclosed herein, preform assembly 170 is disposed within furnace 220 (which may be, for example, a consolidation furnace, a redraw furnace, or a consolidation and draw tower furnace). During the consolidation, furnace 220 is heated by a lower heater 210 that creates a hot zone 215 within the furnace. Hot zone 215 has a maximum temperature within the range of about 1200° C. to about 2100° C., or about 1300° C. to about 1800° C., or about 1400° C. to about 1600° C.

When disposed within furnace 220, preform assembly 170 is slowly lowered towards lower heater 210 as preform assembly 170 is consumed and drawn into an optical fiber. Furthermore, in some embodiments, the above-disclosed vacuum holding process is conducted simultaneously as preform assembly 170 is slowly lowered towards lower heater 210. Therefore, the vacuum pull from vacuum system 180 is conducted while preform assembly 170 is being consumed and drawn into an optical fiber. Furnace 220 may comprise one or more inert gases in addition to preform assembly 170.

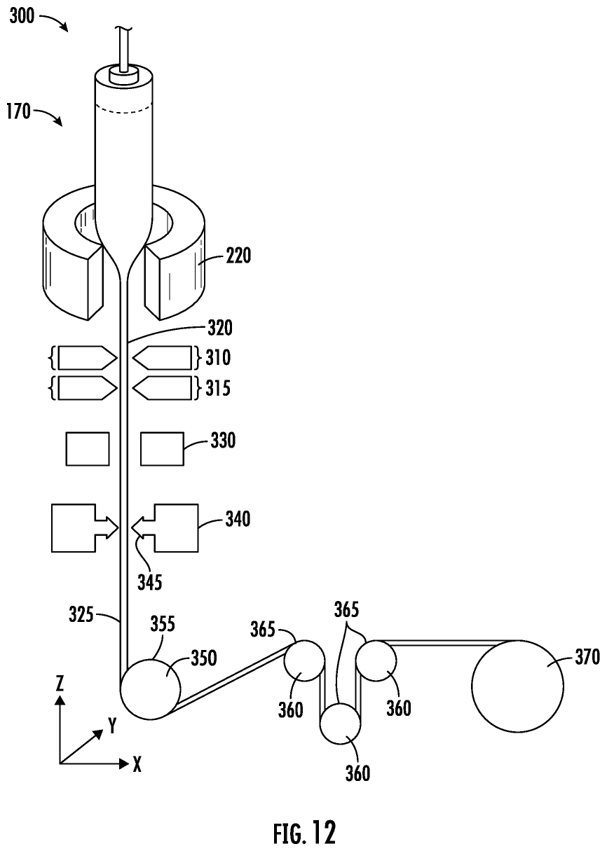

FIG. 12 shows a drawing system 300 for drawing an optical fiber (step 60 of process 1) according to the embodiments disclosed herein. Exemplary drawing system 300 comprises furnace 220, as discussed above. Furthermore, drawing system 300 comprises non-contact measurement sensors 310, 315 for measuring the size (e.g., diameter control) of a drawn (bare) fiber 320 that exits furnace 320. A cooling station 330 resides downstream of the measurement sensors 310, 315 and is configured to cool the bare fiber 320. A coating station 340 resides downstream of cooling station 330 and is configured to deposit a protective coating material 345 onto the bare fiber 320 to form a coated fiber 325. A tensioner 350 resides downstream of the coating station 340. The tensioner 350 has a surface 355 that pulls (draws) the coated fiber 325. A set of guide wheels 360 with respective surfaces 365 resides downstream of the tensioner 350. The guide wheels 360 serve to guide the coated fiber 325, to a fiber take-up spool (“spool”) 370 to store the coated fiber 325. Embodiments of the present disclosure can be used to form a single core optical fiber or a multicore optical fiber.

The processes disclosed herein produce preforms with a devitrification level of about 1.00 ppm or less, or about 0.80 ppm or less, or about 0.75 ppm or less, or about 0.50 ppm or less, or about 0.30 ppm or less, or about 0.25 ppm or less, or about 0.20 ppm or less, or about 0.15 ppm or less, or about 0.10 ppm or less, or about 0.08 ppm or less, or about 0.05 ppm or less, or about 0.02 ppm or less, or about 0.01 ppm or less, or about 0.00 ppm. For purposes of the present disclosure, the devitrification levels disclosed herein were measured using X-ray diffraction analysis (XRD). In particular, in order to measure the devitrification levels disclosed herein, crystallized samples of glass were ground to a fine powder and run on a diffractometer. X-ray diffraction patterns were obtained for each composition and for several temperatures of crystallization. Methods to determine the disclosed devitrification levels using XRD are also disclosed in G. W. Scherer and D. R. Uhlmann, “Diffusion Controlled Crystal-Growth in K₂O—SiO₂ Compositions”, Journal of Non-Crystalline Solids, 23, 59-80 (1977), which is incorporated by reference herein.

While various embodiments have been described herein, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various needs as would be appreciated by one of skill in the art.

It is to be understood that the phraseology or terminology used herein is for the purpose of description and not of limitation. The breadth and scope of the present disclosure should not be limited by any of the above-described exemplary embodiments but should be defined only in accordance with the following claims and their equivalents.

What is claimed is:

1. A method of making a multicore optical fiber preform, the method comprising:
consolidating a preform assembly to form the multicore optical fiber preform,
the preform assembly comprising a plurality of core canes such that each core cane is disposed within an axial hole of a sleeve,
each core cane comprising a core section comprised of alkali doped silica glass such that the silica glass has a maximum alkali concentration between about 0.10 wt. % and about 10 wt. %,
the core section of each core cane being encased by the sleeve along a height of the core cane and by covers disposed at first and second axial ends of the core section, and
the covers comprising silica glass having a chlorine concentration of about 0.05 wt. % or less.

2. The method of claim 1, wherein the alkali is sodium, potassium, rubidium, cesium, or a combination thereof.

3. The method of claim 2, wherein the alkali is potassium.

4. The method of claim 1, wherein the maximum alkali concentration in the alkali doped core section is between about 0.4 wt. % and about 5.0 wt. %.

5. The method of claim 1, wherein:
the maximum alkali concentration is between about 0.50 wt. % and about 10 wt. %, and
consolidating the preform assembly comprises exposing the preform assembly to a temperature T (K) for a time t (sec) such that:
t<tc, and
tc=10^{(1.86×10}^{^{−10}}^{T}^{⁴}^{-9.69×10}^{^{−7}}^{T}^{³}^{+1.91×10}^{^{−3}}^{T}^{²}^{-1.68T+571.9)}, wherein tc is the time (sec) for the glass to crystalize.

6. The method of claim 5, wherein the temperature T is between about 1000 K and about 1925 K.

7. The method of claim 5, wherein the maximum alkali concentration is between about 0.75 wt. % and about 4 wt. %.

8. The method of claim 7, wherein the maximum alkali concentration is between about 0.78 wt. % and about 4 wt. %.

9. The method of claim 1, wherein:
the maximum alkali concentration is between about 0.50 wt. % and about 10 wt. %, and
the method further comprising exposing the preform assembly to a temperature T (K) for a time t (sec) such that:
t<tc, and
tc=10^{(1.86×10}^{^{−10}}^{T}^{⁴}^{-9.69×10}^{^{−7}}^{T}^{³}^{+1.91×10}^{^{−3}}^{T}^{²}^{-1.68T+571.9)}, wherein tc is the time (sec) for the glass to crystalize.

10. The method of claim 9, wherein the temperature T is between about 1000 K and about 1925 K.

11. The method of claim 9, wherein the maximum alkali concentration is between about 0.75 wt. % and about 4 wt. %.

12. The method of claim 11, wherein the maximum alkali concentration is between about 0.78 wt. % wt. % and about 4 wt. %.

13. The method of claim 1, wherein:
the maximum alkali concentration is between about 1.56 wt. % and about 4 wt. %, and
consolidating the preform assembly comprises exposing the preform assembly to a temperature T (K) for a time t (sec) such that:
t<tc, and
tc=10^{(1.67×10}^{^{−10}}^{T}^{⁴}^{-8.68×10}^{^{−7}}^{T}^{³}^{+1.7×10}^{^{−3}}^{T}^{²}^{-1.5T+506)}, wherein tc is the time (sec).

14. The method of claim 13, wherein the temperature T is between about 1000 K and about 1925 K.

15. The method of claim 1, wherein:
the maximum alkali concentration is between about 1.56 wt. % and about 4 wt. %, and
the method further comprising exposing the preform assembly to a temperature T (K) for a time t (sec) such that:
t<tc, and
tc=10^{(1.67×10}^{^{−10}}^{T}^{⁴}^{-8.68×10}^{^{−7}}^{T}^{³}^{+1.7×10}^{^{−3}}^{T}^{²}^{-1.5T+506)}, wherein tc is the time (sec).

16. The method of claim 15, wherein the temperature T is between about 1000 K and about 1925 K.

17. The method of claim 1, wherein a diameter of the first axial end is perpendicular to a height of the alkali doped core section, and a diameter of the second axial end is perpendicular to the height of the alkali doped core section.

18. The method of claim 1, wherein each core cane comprises an inner cladding section disposed radially outward of the alkali doped core section.

19. The method of claim 18, wherein a relative refractive index of the alkali doped core section is greater than a relative refractive index of the inner cladding section.

20. The method of claim 1, wherein a relative refractive index of the alkali doped core is greater than a relative refractive index of the sleeve.
